(19) United States
(12) Patent Application Publication
(10) Pub. No.: US 2018/0232116 A1
(43) Pub. Date: Aug. 16, 2018

(54) USER INTERFACE METHOD AND SYSTEM FOR A MOBILE DEVICE

(71) Applicant: GRAD DNA LTD., Kent (GB)

(72) Inventor: Stephen REILLY, Kent (GB)

(21) Appl. No.: 15/892,822

(22) Filed: Feb. 9, 2018

Related U.S. Application Data
(60) Provisional application No. 62/457,314, filed on Feb. 10, 2017.

(51) Int. Cl. G06F 3/0482; G06F 3/0488; G06F 17/21

(52) U.S. Cl. CPC G06F 3/0482; G06F 17/214; G06F 3/04883

(57) ABSTRACT

The present invention relates to a method for confirming selection of an answer in a test on a mobile device. The method includes displaying a user interface element in a first state to a user on the mobile device, wherein the user interface element corresponds to one of a plurality of answers within the test; receiving a first input from the user at the user interface element; in response to the first input, displaying the user interface element in a second state to the user on the mobile device; receiving a second input from the user at the user interface element; and in response to the second input, confirming selection of the answer corresponding to the user interface element. A system for providing a user interface and software for confirming selection of an answer in a test are also disclosed.

### FIELD OF INVENTION

The present invention is in the field of user interfaces. More particularly, but not exclusively, the present invention relates to a user interface for a test environment on a mobile device.

### BACKGROUND

Psychometric and ability testing was originally performed using pencil and paper where an eraser was used to erase any mistakes. When testing went onto desktop computers the user interface often included a selection button to select the answer and a submit button to submit the answer and progress to the next question.

It would be desirable to be able to provide testing via mobile devices. However, the current user interface devised for desktop computers may be not be suitable for the form-factor of mobile devices which tend to be smaller and hand-held.

There is, therefore, a desire for an improved user interface suitable for mobile devices.

It is an object of the present invention to provide a user interface method and system which overcomes the disadvantages of the prior art, or at least provides a useful alternative.

### SUMMARY OF INVENTION

According to a first aspect of the invention there is provided a method for confirming selection of an answer in a test on a mobile device, including:

Displaying a user interface element in a first state to a user on the mobile device, wherein the user interface element corresponds to one of a plurality of answers within the test;

Receiving a first input from the user at the user interface element;

In response to the first input, displaying the user interface element in a second state to the user on the mobile device;

Receiving a second input from the user at the user interface element; and

In response to the second input, confirming selection of the answer corresponding to the user interface element.

The first input and the second input may be the same type of input action. The input action may be one of a gesture on a touch/near-touch-screen, pointer device click, or touch-pad click.

Confirmation of selection of the answer may only occur when the second input is received after the expiration of a delay period from the first input.

The first input and the second input may be different types of input actions. The input action for the second input may be a hard press on a 3D touch input device, a touch gesture, or a circular gesture on a touch input device. The input action for the second input may be a continuation beyond a time threshold of a press input action for the first input.

A plurality of user interface elements corresponding to the plurality of answers may be displayed simultaneously on the screen of the mobile device.

The test may be a psychometric test.

The first and second state may correspond to visual changes in the user interface element. The visual changes may include colour change, font change, image change, and/or size change.

According to a further aspect of the invention there is provided a system for providing a user interface on a mobile device, including:

A mobile device comprising:
A display; and
An input apparatus; and

A processor configured to display a user interface element in a first state to a user on the display, wherein the user interface element corresponds to one of a plurality of answers within a test, to receive a first input from the user at the user interface element via the input apparatus, in response to the first input, to display the user interface element in a second state to the user on the display; to receive a second input from the user at the user interface element via the input apparatus, and in response to the second input, to confirm selection of the answer corresponding to the user interface element.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a block diagram illustrating a device software architecture in accordance with an embodiment of the invention;

FIG. 3: shows a flow diagram illustrating a method in accordance with an embodiment of the invention; and

FIGS. 4a to 8e:
show diagrams illustrating user interaction with screens generated by a software application executing in accordance with methods of embodiments of the invention.

### DETAILED DESCRIPTION OF PREFERRED EMBODIMENTS

The present invention provides a user interface method and system for confirming selection of an answer on the mobile device.

The inventor notes that for many testing environments, it is desirable to provide the ability for a user to be able to confirm their selection of an answer. This prevents mistakes by the user and/or provides the user time to think about the accuracy of their selection.

On mobile devices, the screen size is significantly smaller than desktop computers. Providing both selection and confirmation buttons within a user interface would result in an interface that is either/both crowded and/or requires a user to scroll from the selection button to the confirmation button. Either of these can impact negatively upon the validity of user tests, particularly psychometric testing where users must be in a certain state of mind.

The inventor has discovered that multiple actions in relation to a single user interface element can be used to both select and confirm selection by visually modifying the element after the first action.

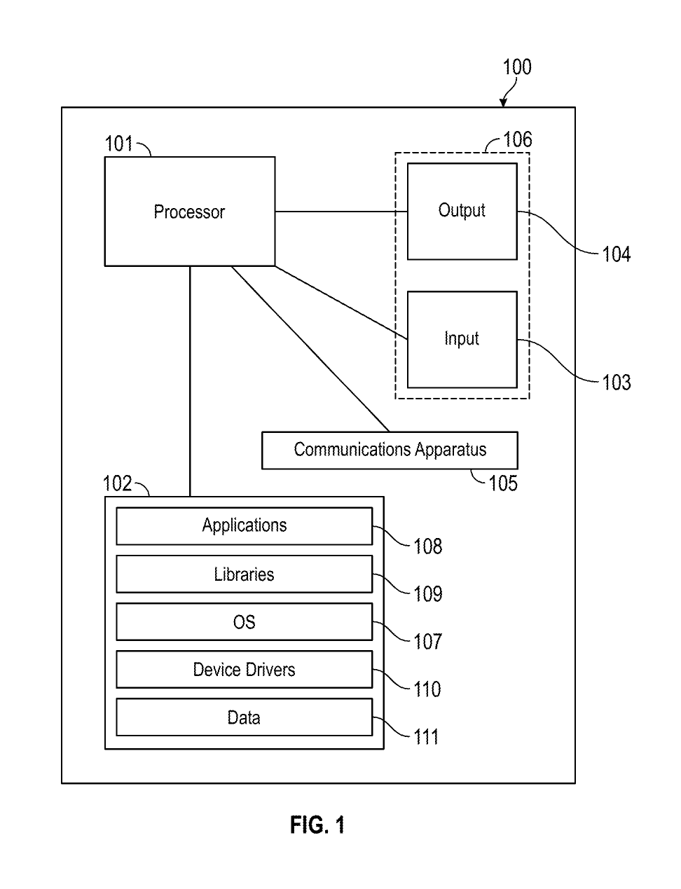

In FIG. 1, a system 100 in accordance with an embodiment of the invention is shown.

The system 100 includes a processor 101, a memory 102, an input apparatus 103, and a display apparatus 104. The system may also include a communications apparatus 105.

The input apparatus 103 may include one or more of a touch/near-touch input, an audio input, a keyboard, a pointer device (such as a mouse), or any other type of input. The touch input may include 3D touch. 3D touch inputs detect varying degrees of pressure. A common 3D touch input interface provided on iPhone 6S and 6S plus devices distinguish between a normal press and a hard press.

The display apparatus 104 may include one or more of a digital screen (such as an LED or OLED screen), an e-ink screen, or any other type of display.

The input and display apparatuses 103 and 104 may form an integrated user interface 106 such as a touch or near-touch screen.

The system 100, or at least parts of the system, constitute a mobile device 100, such as a smart-phone, a tablet, or a smartwatch. The mobile device 100 may include a common operating system 107 such as Apple iOS, Google Android, or Microsoft Windows Phone.

The system 100 may be configured to provide multi-functionality such as execution of one or more software applications 108, transmitting and receiving communications (e.g. voice communications, text messages, notifications, or any other network communications), and/or monitoring communications or applications and generating notifications. The multi-functionality may be coordinated by the operating system 107 executing on the device 100.

The processor 101 may be configured to display user interface elements in first and second states on the display apparatus 104. The processor 101 may be configured to change the state of the user interface elements from the first state to the second in response to a first user input via the input apparatus 103 at the user interface element. The states may be reflected as visual differences on the display.

The processor 101 may be further configured to provide a test to the user. The test may be a series of questions displayed on the display apparatus 104, for example, the test may be displayed as a series of screens each screen corresponding to one or more of the questions. Each of the screens may include the display of one or more user interface elements, each user interface element corresponding to a possible answer for a question.

The processor 101 may be further configured to confirm selection of an answer to a question when receiving a second user input at the corresponding user interface element when the user interface element is a second state.

In one embodiment, the processor 101 provides the test by execution of a testing application.

The memory 102 may be configured to store the software applications 108, libraries 109, the operating system 107, device drivers 110, and data 111. The data 111 may include the test and answers provided by a user to the test. The software applications 108 may include the testing application and one or more third party applications.

The processor 101 is configured to execute the software applications 108, libraries 109, operating system 107, and device drivers 110, and to retrieve data 111.

The communications apparatus 105 may be configured to communicate with one or more other devices or servers via a communications interface such as wifi, Bluetooth, and/or cellular (e.g. 2G, 3G, or 4G) and/or across a network (such as a cellular network, a private LAN/WLAN and/or the Internet).

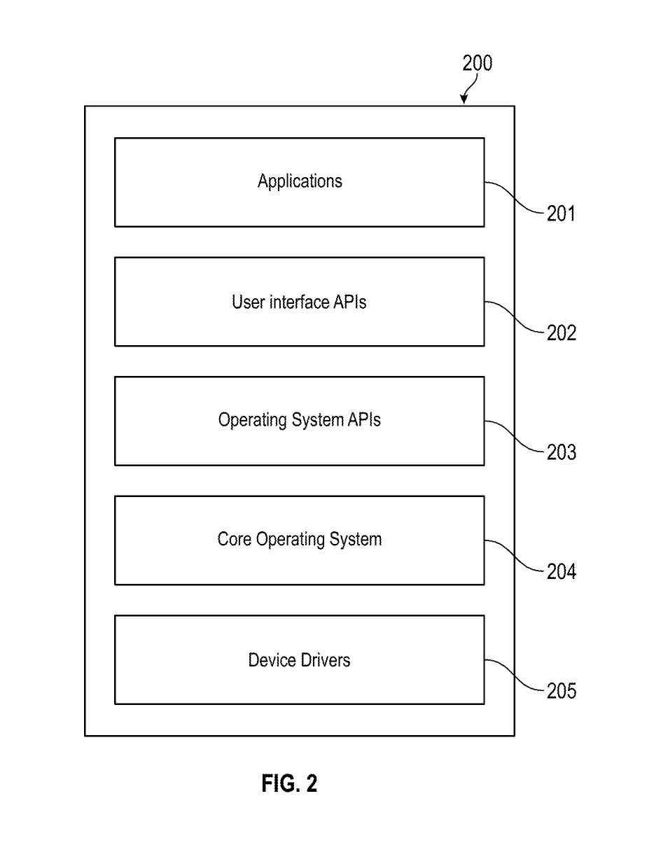

Referring to FIG. 2, the various layers of the architecture 200 of the device 100 will be described.

Software applications 201 are provided at a top layer. Below this layer are user interface APIs 202 which provide access for the application software 201 to user interface libraries. Below this layer are operating system APIs 203 which provide access for the application software 201 and user interface libraries to the core operating system 204. Below the core operating system 204 are the device drivers 205 which provide access to the input 103, output 104, and communication 105 apparatuses.

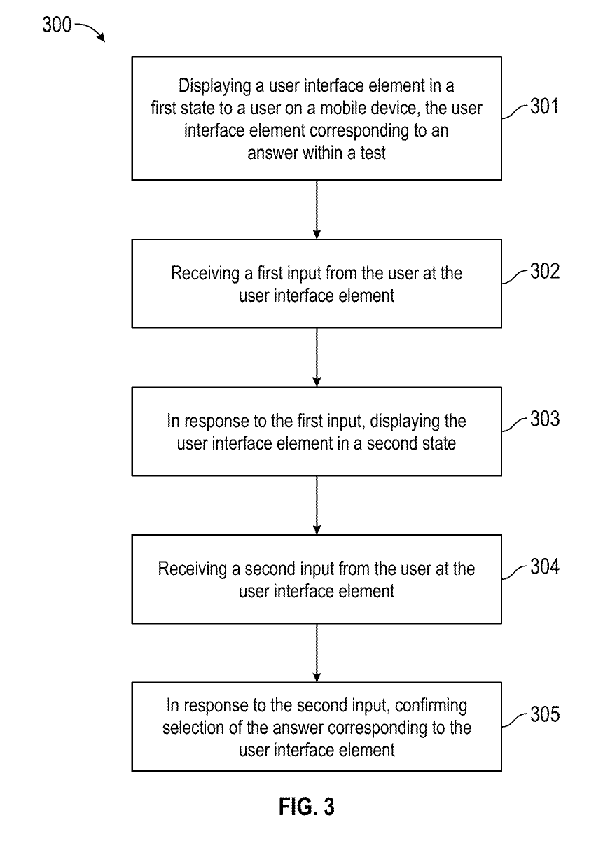

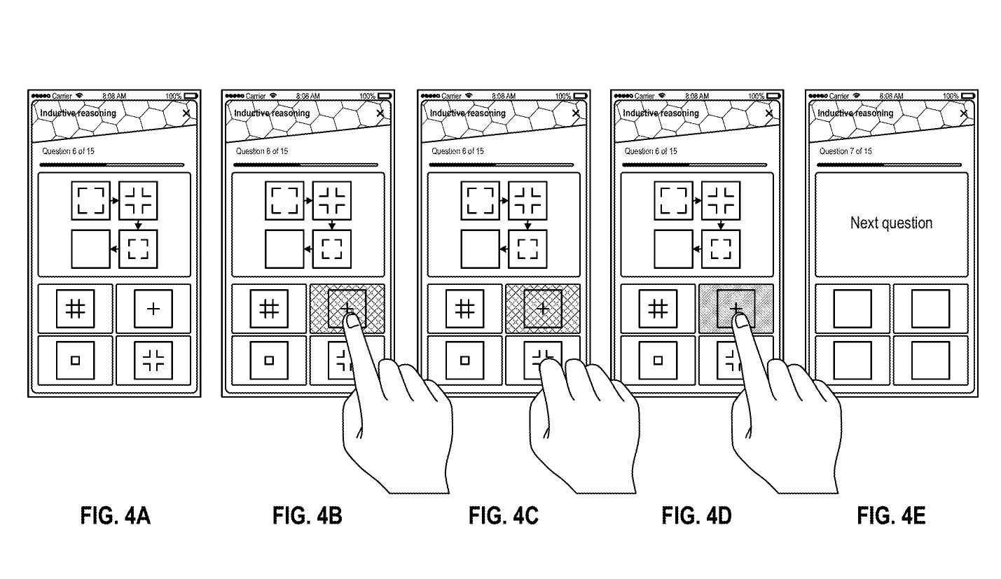

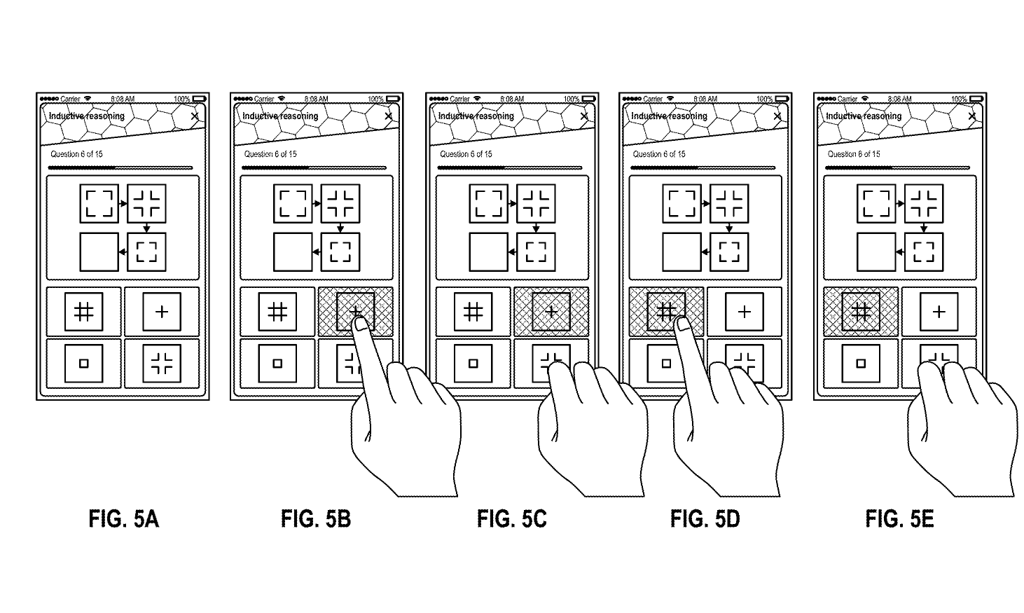

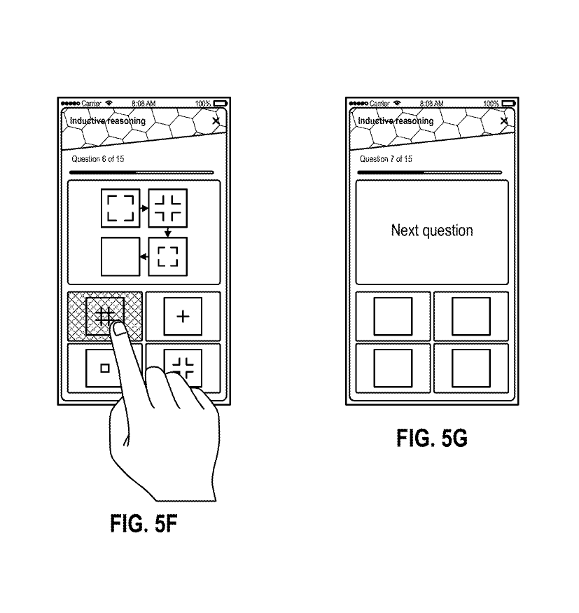

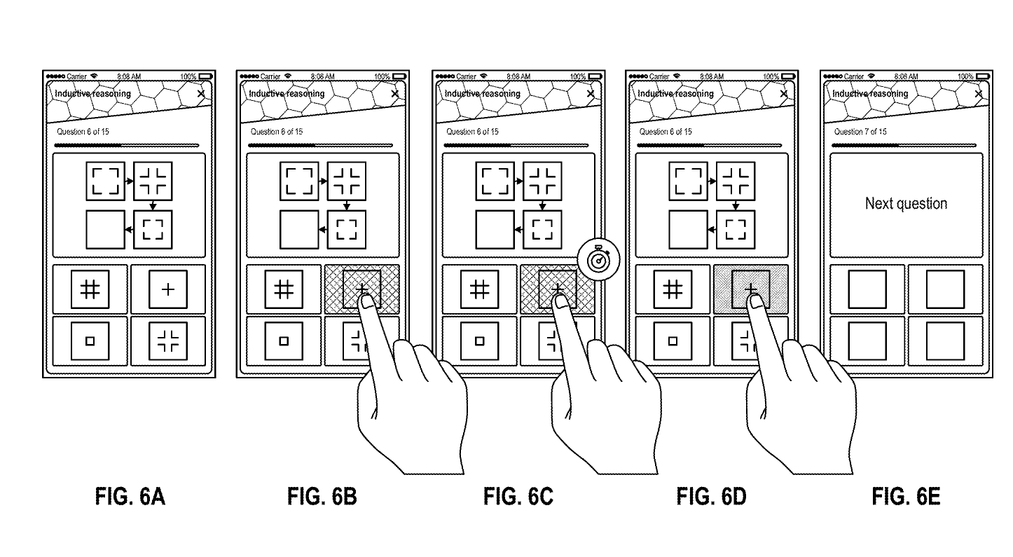

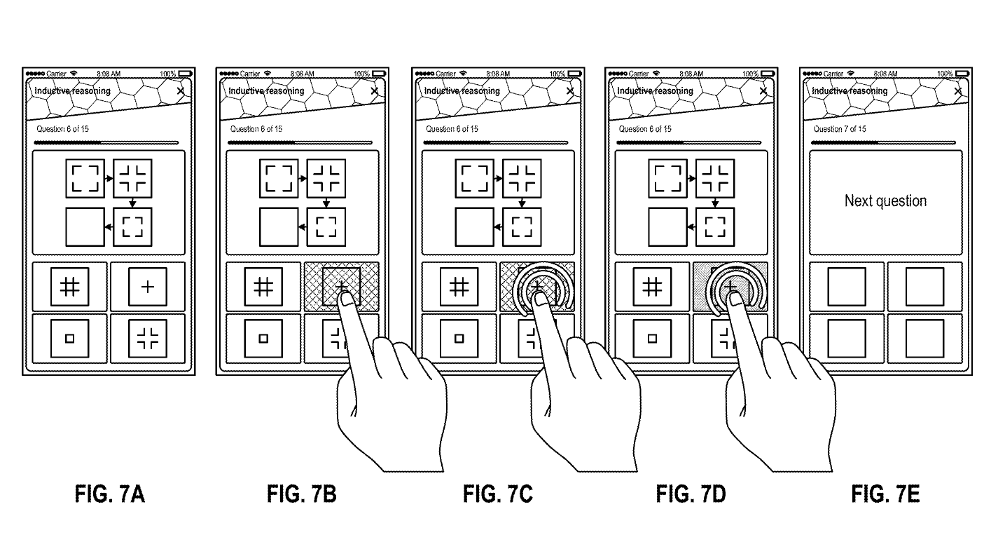

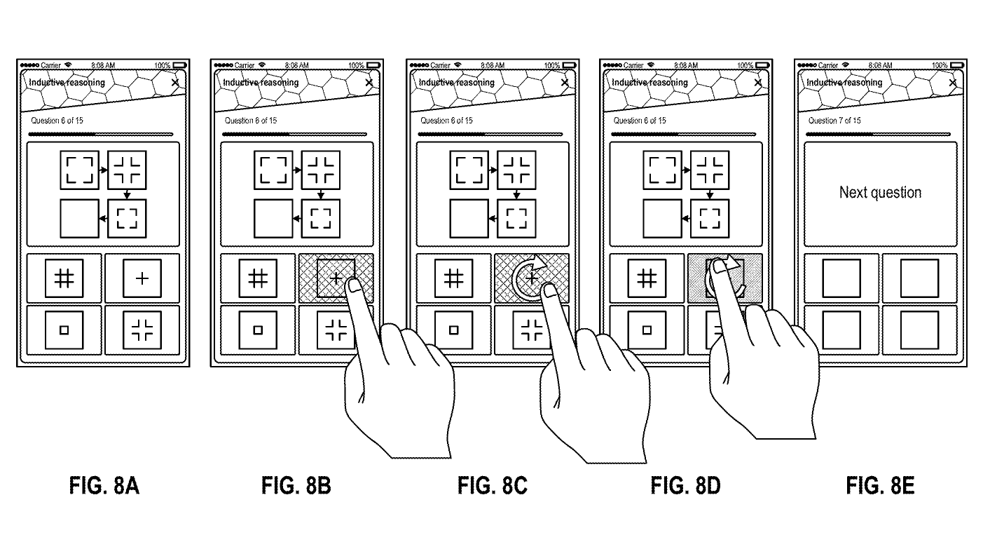

With reference to FIG. 3, a method 300 in accordance with an embodiment of the invention will be described.

In step 301, a user interface element is displayed in a first state to a user on a mobile device (e.g. on display apparatus 104). The user interface element may correspond to one of a plurality of answers within a test, such as a psychometric test. The user interface element may be displayed in conjunction (i.e. simultaneously) on the screen with one or more additional user interface elements. Each of the user interface elements may correspond to different answers to a question within the test. The user interface element may be a button widget, an icon, or any other visual indicator.

In step 302, a first input from the user is received at the user interface element. The first input may be an input action, such as a gesture (such as touch, double-touch, or any other gesture) on a touch-screen or near-touch screen, a pointer device click, or a touch-pad click.

In step 303, in response to the first input, the user interface element is displayed in a second state to the user on the mobile device (e.g. on display apparatus 104). The difference in the first state and second state may be reflected as a visual change in the user interface element. The visual change may be a colour change, font change, image change, and/or size change related to the user interface element.

In step 304, a second input is received from the user at the user interface element. In one embodiment, the second input may be the same type of input as the first input. In an alternative embodiment, the second input may be a different type of input.

The second input may be:
a hard press on a 3D touch input apparatus;
a touch gesture, such as a circular gesture; or
continuation of an action of the first input beyond a defined time threshold (e.g. a touch gesture for the first input that lasts beyond 2 seconds).

In step 305, in response to the second input, confirming selection of the answer corresponding to the user interface element.

Exemplary code for receiving the second input on an Android device is provided below:

function
submissionListener(userId,testId,questionId,answerId,n,ti
meTaken) {

//Called when a test is started. Listens for a

submission event.

var userId = userId ;
var testId = testId ;
var questionId = questionId ;
var answerId = answerId ;
var timeThreshold = n ;
var timeTaken = timeTaken ;
if ( submissionEvent === doubleclick ||

submissionEvent === increasePressure ||
submissionEvent === clockwiseSwirl ||
submissionEvent === anticlockwiseSwirl

) {

//Event has no time threshold, so simply submit

the answer

submitAnswer(userId,testId,questionId,answerId);
} else if (submissionEvent === holdDown) {

//Event has a time threshold. If this has been

met, submit the answer

if (timeTaken >= timeThreshold) {

submitAnswer(userId,testId,questionId,answerId);

}

} else {

//No event so do nothing

}

}

In one embodiment, after selecting a user interface element using a first user input but before the answer is confirmed, the user may choose a second user interface element via another user input. In this embodiment, the first user interface element is deselected and the answer corresponding to the second user interface element is confirmed via a second user input at that second user interface element.

FIGS. 4a to 4e show diagrams illustrating a sequence of user interactions with screenshots generated by a software application in accordance with a method of the invention.

A question and four user interface elements are first displayed to the user as shown in FIG. 4a, each element corresponding to a possible answer to the question.

The device receives a first user input being a press or touch at one of the user elements to select the answer corresponding to the user element. The visual state of the user element is changed to a darker version in response to receipt of the first input as shown in FIG. 4b.

FIG. 4c shows no interaction by the user and the user element corresponding to the selected answer maintaining its modified visual state.

FIG. 4d shows the device receiving a second user input being another press or touch at the user element corresponding to the selected answer to confirm the answer. In this example, the visual state of the user element is changed again to an even darker version in response to receipt of the second input and the answer is confirmed by the device.

After confirmation, a closing screen is shown in FIG. 4e.

FIGS. 5a to 5g show diagrams illustrating a sequence of user interactions with screenshots generated by a software application in accordance with a method of the invention.

These figures illustrate the same method shown in FIGS. 4a to 4e but where a user changes their answer selection before the answer is confirmed.

A question and four user interface elements are first displayed to the user as shown in FIG. 5a, each element corresponding to a possible answer to the question.

The device receives a first user input being a press or touch at one of the user elements to select the answer corresponding to the user element. The visual state of the user element is changed to a darker version in response to receipt of the first input as shown in FIG. 5b.

FIG. 5c shows no interaction by the user and the user element corresponding to the selected answer maintaining its modified visual state.

The device receives another user input being a press or touch at an alternative user element to select a different answer corresponding to that user element. The visual state of this user element is changed to a darker version in response to receipt of the further input as shown in FIG. 5d.

FIG. 5e shows no interaction by the user and the user element corresponding to the alternatively selected answer maintaining its modified visual state.

FIG. 5f shows the device receiving a yet further user input being another press or touch at the user element corresponding to the alternatively selected answer to confirm the answer. In this example, the visual state of the user element is changed again to an even darker version in response to receipt of this yet further input and the answer is confirmed by the device.

After confirmation, a closing screen is shown in FIG. 5g.

FIGS. 6a to 6e show diagrams illustrating a sequence of user interactions with screenshots generated by a software application in accordance with a method of the invention.

A question and four user interface elements are first displayed to the user as shown in FIG. 6a, each element corresponding to a possible answer to the question.

The device receives a first user input being a press or touch at one of the user elements to select the answer corresponding to the user element. The visual state of the user element is changed to a darker version in response to receipt of the first input as shown in FIG. 6b.

FIG. 6c shows a first user input continuing for a period of time and the user element corresponding to the selected answer maintaining its modified visual state.

FIG. 6d shows the device receiving the continued first user input as a second user input due to the continuation of the first user input exceeding a defined time threshold to confirm the answer. In this example, the visual state of the user element is changed again to an even darker version in response to receipt of this second input and the answer is confirmed by the device.

After confirmation, a closing screen is shown in FIG. 6e.

FIGS. 7a to 7e show diagrams illustrating a sequence of user interactions with screenshots generated by a software application in accordance with a method of the invention.

A question and four user interface elements are first displayed to the user as shown in FIG. 7a, each element corresponding to a possible answer to the question.

The device receives a first user input being a press or touch at one of the user elements to select the answer corresponding to the user element. The visual state of the user element is changed to a darker version in response to receipt of the first input as shown in FIG. 7b.

FIG. 7c shows the first user input continuing and at greater pressure for the press and the user element corresponding to the selected answer maintaining its modified visual state.

FIG. 7d shows the device receiving a second user input due to the pressure of the first user input exceeding an input threshold for a 3D touch input apparatus to confirm the answer. In this example, the visual state of the user element is changed again to an even darker version in response to receipt of the second input and the answer is confirmed by the device.

After confirmation, a closing screen is shown in FIG. 7e.

FIGS. 8a to 8e show diagrams illustrating a sequence of user interactions with screenshots generated by a software application in accordance with a method of the invention.

A question and four user interface elements are first displayed to the user as shown in FIG. 8a, each element corresponding to a possible answer to the question.

The device receives a first user input being a press or touch at one of the user elements to select the answer corresponding to the user element. The visual state of the user element is changed to a darker version in response to receipt of the first input as shown in FIG. 8b.

FIG. 8c shows the first user input continuing and being modified into a gesture and the user element corresponding to the selected answer maintaining its modified visual state.

FIG. 8d shows the device receiving a second user input being the first user input converted into a completed circular touch gesture to confirm the answer. In this example, the visual state of the user element is changed again to an even darker version in response to receipt of the second input and the answer is confirmed by the device.

After confirmation, a closing screen is shown in FIG. 8e.

A potential advantage of some embodiments of the present invention is that an improved user interface is provided which enables confirmation of test answer selections to be made within the constraints of the display of mobile devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for confirming selection of an answer in a test on a mobile device, including:
Displaying a user interface element in a first state to a user on the mobile device, wherein the user interface element corresponds to one of a plurality of answers within the test;
Receiving a first input from the user at the user interface element;
In response to the first input, displaying the user interface element in a second state to the user on the mobile device;
Receiving a second input from the user at the user interface element; and
In response to the second input, confirming selection of the answer corresponding to the user interface element.

2. A method as claimed in claim 1, wherein the first input and the second input are the same type of input action.

3. A method as claimed in claim 2, wherein the input action is one selected from the set of a gesture on a touch/near-touch-screen, pointer device click, and touch-pad click.

4. A method as claimed in claim 1, wherein confirmation of selection of the answer occurs only when the second input is received after the expiration of a delay period from the first input.

5. A method as claimed in claim 1, wherein the first input and the second input are different types of input actions.

6. A method as claimed in claim 5, wherein the input action for the second input is a hard press on a 3D touch input device.

7. A method as claimed in claim 5, wherein the input action for the second input is a touch gesture.

8. A method as claimed in claim 7, wherein the touch gesture is a circular gesture on a touch input device.

9. A method as claimed in claim 5, wherein the input action for the second input is a continuation beyond a time threshold of a press input action for the first input.

10. A method as claimed in claim 1, wherein a plurality of user interface elements corresponding to the plurality of answers are displayed simultaneously on the screen of the mobile device.

11. A method as claimed in claim 1, wherein the test is a psychometric test.

12. A method as claimed in claim 1, wherein the first and second state correspond to visual changes in the user interface element.

13. A method as claimed in claim 12, wherein the visual changes include one or more selected from the set of colour change, font change, image change, and size change.

14. A system for providing a user interface on a mobile device, including:
A mobile device comprising:
A display apparatus; and
An input apparatus; and
A processor configured to display a user interface element in a first state to a user on the display, wherein the user interface element corresponds to one of a plurality of answers within a test, to receive a first input from the user at the user interface element via the input apparatus, in response to the first input, to display the user interface element in a second state to the user on the display; to receive a second input from the user at the user interface element via the input apparatus, and in response to the second input, to confirm selection of the answer corresponding to the user interface element.

15. A tangible computer readable medium storing a computer program configured to perform the method of claim 1.
